(19) United States
(12) Patent Application Publication
(10) Pub. No.: US 2008/0184047 A1
(43) Pub. Date: Jul. 31, 2008

(54) System and method for implementing a quiet operating mode in a computing system

(76) Inventor: Courtney D. Goeltzenleuchter, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/657,820

(22) Filed: Jan. 25, 2007

(51) Int. Cl. G06F 1/32

(52) U.S. Cl. 713/320

(57) ABSTRACT

A computing system comprising a module configured to receive an indication to enter a quiet operating mode and, in response to the request, maintain power consumption of at least one element of the computing system at a reduced level while enabling use of the computing system in the quiet operating mode.

### BACKGROUND OF THE INVENTION

Cooling fans are often used in computers to remove heat that is generated by electrical components such as integrated circuits (ICs). Generally, the faster an IC runs (i.e. the faster its clock rate is), the more electrical energy it consumes, which increases the amount of heat it produces. High performance central processing units (CPUs) and other ICs, including processors on some video graphics cards, require relatively high capacity fans to dissipate the heat generated by the components. Unfortunately, these fans produce considerable noise.

### BRIEF DESCRIPTION OF THE DRAWINGS

For a more complete understanding of the present invention, the objects and advantages thereof, reference is now made to the following descriptions taken in conjunction with the accompanying drawings, in which:

FIG. 1 is a block diagram illustrating an embodiment of a computing system having a quiet operating mode; and

FIG. 2 is a flow diagram illustrating an embodiment of a method for implementing a quiet operating mode for a computing system.

### DETAILED DESCRIPTION OF THE DRAWINGS

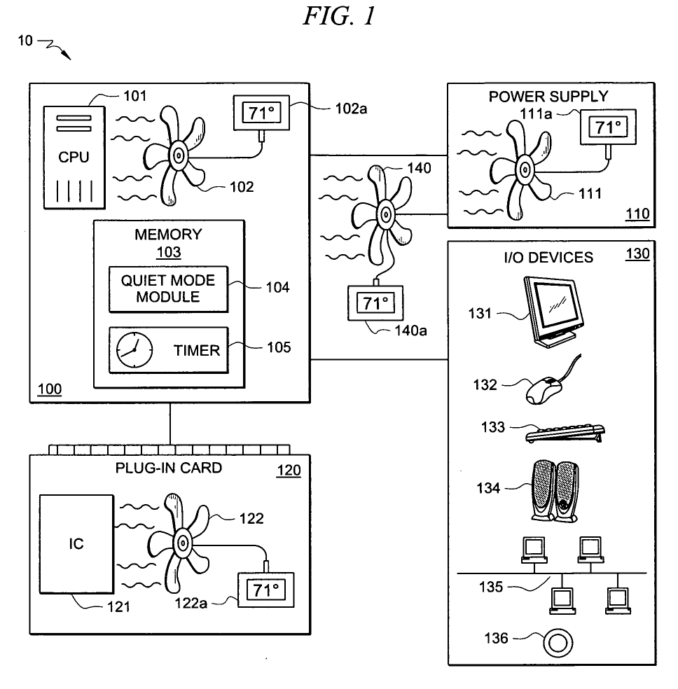

FIG. 1 is a block diagram illustrating an embodiment of a computing system 10 having a quiet operating mode that is configured to reduce the noise produced by computing system 10 when desired by a user. In some embodiments, a quiet operating mode is a mode of operation in which the clock speed and/or voltage level of one or more integrated circuits (ICs) in computing system 10 is reduced and maintained at the reduced level so that the IC draws less electric power, even though computing system 10 remains operational and able to continue accepting and processing user input. With a lower power draw, computing system 10 produces less heat, which enables at least one thermostatically-controlled fan to reduce its speed and, therefore, reduce the accompanying noise therefrom. In some embodiments, the quiet operating mode further comprises muting or silencing of other sounds produced by computing system 10, such as audible signals. In some embodiments, the quiet operating mode further comprises preventing use of one or more components/elements of computing system 10 that, if used, would result in the production/emission of an unacceptable level of noise (e.g., the ejection of a disk or other type of drive device, the powering-up/using of the drive device, etc.). In some embodiments, the quiet operating mode remains in effect, despite possible attempts by an operating system or other application (i.e., an application apart from an application controlling the quiet operating mode) to increase clock speeds or IC operating voltages.

In the embodiment illustrated in FIG. 1, computing system 10 comprises a motherboard 100, a power supply 110, a plug-in card 120, an input/output (I/O) device(s) 130 and a chassis fan 140. It should be understood that computing system 10 may comprise a desktop computer, notebook computer, portable computer, gaming device, music device, personal digital assistant (PDA), or other type of computing device. Motherboard 100 is coupled to power supply 110, plug-in card 120, I/O device(s) 130 and chassis fan 140. Motherboard 100 comprises a central processing unit (CPU) 101 which processes instructions and data to implement a quiet operating mode as well as other instructions and data used to accomplish the various operating functions of computing system 10. In the embodiment illustrated in FIG. 1, a thermostatically-controlled fan 102, which is preferably disposed near CPU 101 and powered through motherboard 100, provides cooling for CPU 101.

Motherboard 100 also comprises a memory 103 coupled to CPU 101. Memory 103 may comprise volatile, non-volatile and permanent storage, including digital media drives. Memory 103 comprises a quiet operating mode module 104, which comprises data and instructions processed by CPU 101 to implement a quiet operating mode for computing system 10, and a timer 105 that provides timing information for use by quiet operating mode module 104. Quiet operating mode module 104 may comprise hardware, software, firmware, or a combination thereof. In FIG. 1, quiet operating mode module 104 is illustrated as being stored in memory 103 so as to be accessible and executable by CPU 101. However, it should be understood that quiet operating mode module 104 may be otherwise located. It should further be understood that although motherboard 100 is illustrated in FIG. 1 as a single circuit board, it may comprise a collection of circuit boards, and that portions of memory 103 may reside off motherboard 100.

In the embodiment illustrated in FIG. 1, power supply 110 provides power to motherboard 100, plug-in card 120, possibly one or more of I/O device(s) 130 and chassis fan 140. Power supply 110 may comprise a battery and/or a power converter for use with an external power connection. In FIG. 1, power supply 11 also comprises a thermostatically-controlled fan 111 for cooling power supply 110 when a temperature of power supply 110 exceeds a threshold (e.g., fan 111 is actuated in response to detecting temperature exceeding a predetermined threshold).

In the embodiment illustrated in FIG. 1, plug-in card 120 comprises an IC 121, such as a graphics processor unit (GPU), memory or a memory controller, and a thermostatically-controlled fan 122. In operation, in response to the temperature of IC 121 exceeding a predetermined threshold, fan 122 turns on to provide cooling for IC 121. In some embodiments, chassis fan 140 is also thermostatically-controlled so that it turns on when the temperature of computing system 10 exceeds a threshold. Fans 102, 111, 122 and 140 comprise thermostatic control switches 102a, 111a, 122a and 140a, respectively, which may be mounted on fans 102, 111, 122 and 140 or else on a temperature-monitored device, such as CPU 101 and/or IC 121. Fans 102, 111, 122 and 140 are preferably configured to reduce speed or turn off when the monitored temperature(s) decrease below a predetermined threshold. Alternatively, fans 102, 111, 122 and 140 may be jointly controlled by a single thermostatic control switch, such as one of thermostatic control switches 102a, 111a, 122a and 140a.

In the embodiment illustrated in FIG. 1, I/O device(s) 130 comprise a display 131, a mouse, 132, a keyboard 133, speakers 134, a network connection 135 and a quiet operating mode button 136. Display 131 provides visual indication of any user-oriented messages for quiet operating mode module 104 and enables display of an interface that enables a user to interact with quiet operating mode module 104. Mouse 132 and keyboard 133 provide means for user input that can control quiet operating mode module 104. For example, in some embodiments, a graphical user interface (GUI) associated with quiet operating mode module 104 is displayed on display 131 such that mouse 132 and/or keyboard 133 enable a user to interact with the GUI to place computing system 10 into a quiet operating mode or take computing system 10 out of a quiet operating mode. Speakers 143 may be used to play sounds, such as alerts and music. In some embodiments, when computing system 10 is in a quiet operating mode, quiet operating mode module 104 mutes and/or otherwise prevents the output of sounds that would otherwise be output by speakers 134. Network connection 135 enables computing system 10 to connect to other computing systems and/or networks. In some embodiments, a remote computing system may cause computing system 10 to enter or exit a quiet operating mode by using network connection 135. In some embodiments, quiet operating mode button 136 comprises a depressable button, touch-sensitive element or other device for receiving a user's input for controlling quiet operating mode module 104. For example, in some embodiments, quiet operating mode button 136 causes quiet operating mode module 104 to toggle the quiet operating mode between on and off.

In some embodiments of operation, quiet operating mode module 104 causes a clock rate of CPU 101 and/or IC 121 to slow and/or reduces an operating voltage of CPU 101 and/or IC 121 such that CPU 101 and/or IC 121 draw less electrical power, thereby reducing the electrical current demand on power supply 110, reducing power consumption and resulting in a decrease in the temperatures of CPU 101, IC 121 and/or power supply 110. As the temperatures drop, fans 102, 111, 122 and 140 reduce speed or stop entirely. Thus, the noise that had been produced by fans 102, 111, 122 and 140 is then reduced, thereby enabling computing system 10 to operate quietly. In some embodiments, quiet operating mode module 103 causes the clock rates of CPU 101 and/or IC 121 to slow individually, providing different levels of a quiet operating mode. For example, in some embodiments, quiet operating mode module 103 causes the clock rate of IC 121 to slow and/or the operating voltage to drop to a first level of quiet operating mode, but if the user desires a quieter level of operation, quiet operating mode module 103 causes the clock rate and/or operating voltage of CPU 101 to reduce in addition or in substitution of the clock and/or voltage reductions for IC 121. It should also be understood that quiet operating mode module 104 may cause a reduction in a clock rate, operating voltage, or other operating parameter, or even prevent the use of, other components of computing system 10 and also components coupled to computing system 10 (e.g., an external hard drive or other device coupled to computing system 10). In some embodiments, quiet operating mode module 104 maintains computing system 10 in the quiet operating mode until a request to exit the quiet operating mode is received by quiet operating mode module 104.

When computing system 10 is taken out of quiet operating mode, quiet operating mode module 103 resumes and/or otherwise causes computing system 10 to resume pre-quiet mode operations such that the clock rates and the operating voltage of CPU 101 and/or IC 121 are increased (i.e., if they had been previously decreased by entering quiet operating mode). Thus, one or more of fans 102, 111, 122 and 140 will turn on or increase speed to compensate for increased heat production as necessary. Computing system 10 can be placed into quiet operating mode by user input (e.g., using mouse 132 or keyboard 133 in conjunction with a GUI or other type of interface), by remote command (e.g., using network connection 135), as a scheduled event (e.g., triggered by timer 105 and/or a calendar item such as a scheduled meeting) or by actuating quiet operating mode button 136. In some embodiments, quiet operating mode module 104 is configured so that if computing system 10 is left powered on overnight, quiet operating mode module 104 automatically places computing system 10 into quiet operating mode when timer 105 indicates a predetermined time or in response to a predetermined elapsed time with no user activity. Similarly, computing system 10 can be taken out of quiet operating mode by user input, remote command or as a scheduled event. For example, quiet operating mode module 104 may be configured so that if computing system 10 is put into quiet operating mode, quiet operating mode module 104 monitors the elapsed time using timer 105 and automatically takes computing system 10 out of quiet operating mode after a predetermined duration. Further, quiet operating mode module 104 may be configured such that, in response to the expiration of a scheduled event (e.g., a calendar-scheduled meeting), quiet operating mode module 104 automatically takes computing system out of the quiet operating mode.

In some embodiments, quiet operating mode module 104 monitors keyboard 133 for the activation of certain keys that quiet operating mode module 104 interprets as a command to enter quiet operating mode, exit quiet operating mode, and/or open the GUI associated with quiet operating mode module 104. For example, a certain Function key, or keys pressed along with the “Ctrl” or “Alt” may comprise user input for turning quiet operating mode on or off. In some embodiments, keyboard 133 may have a reserved or new key for controlling quiet operating mode module 104. In some embodiments, computing system 10 may comprise a quiet operating mode button 136 that is independent of keyboard 133 that signals quiet operating mode module 104 to toggle a quiet operating mode on and off.

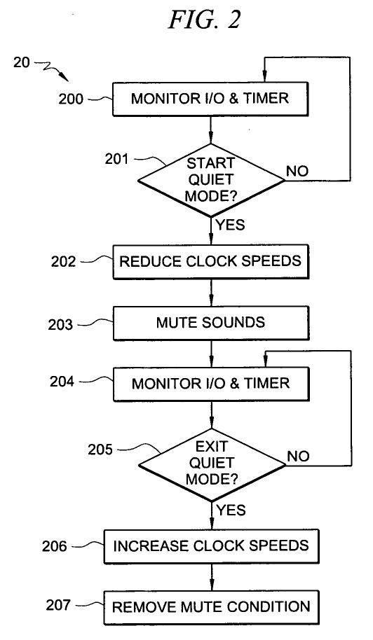

FIG. 2 is a flow diagram illustrating an embodiment of a method 20 for implementing a quiet operating mode for computing system 10. At block 200, quiet operating mode module 104 monitors mouse 132, keyboard 133, network connection 135, quiet operating mode button 136 and/or timer 105 for a signal to enter quiet operating mode. At decision block 201, quiet operating mode module 104 determines whether an input comprises an instruction to start quiet operating mode. If an input to start quiet operating mode is not received, quiet operating mode module 104 continues to monitor for an input at block 200. If quiet operating mode module 104 does identify a signal to start quiet operating mode, quiet operating mode module 104 sends a signal to CPU 101 and/or IC 121 at block 202 that causes CPU 101 and/or IC 121 to reduce their respective clock speed and/or operating voltage, and operating mode module 104 maintains the reduced operating levels CPU 101 and/or IC 121.

At block 203, quiet operating mode module 104 mutes audio signals sent to speakers 134 and/or other devices which may produce audio noise in computing system 10. For example, quiet operating mode module 104 may reduce audio volume or turn speakers 134 off entirely, and additionally may prevent or reduce the operation of devices such as digital media drives (DMDs) that cause noise through mechanical vibrations. At block 204, quiet operating mode module 104 monitors mouse 132, keyboard 133, network connection 135, quiet operating mode button 136 and/or timer 105 for a signal to exit quiet operating mode. At decision block 205, quiet operating mode module 104 determines if an input comprises an instruction to stop quiet operating mode. If it is not, quiet operating mode module 104 resumes monitoring at block 204. If, however, quiet operating mode module 104 does identify a signal to exit quiet operating mode, quiet operating mode module 104 sends a signal to CPU 101 and/or IC 121 at block 206 that indicates that CPU 101 and/or IC 121 may resume normal operations (e.g., increase their respective clock speed and/or operating voltage as necessary based on normal operating and/or processing requirements) at block 202. At block 207, quiet operating mode module 104 removes the mute condition that muted audio signals.

It should be understood that in the described method, certain functions may be omitted, accomplished in a sequence different from that depicted in FIG. 2, or simultaneously performed. Also, it should be understood that the method depicted in FIG. 2 may be altered to encompass any of the other features or aspects as described elsewhere in the specification. Further, embodiments may be implemented in software and can be adapted to run on different platforms and operating systems. In particular, functions implemented by quiet operating mode module 104, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

What is claimed is:

1. A method for a computing system, comprising:
in response to receiving an indication by the computing system to enter a quiet operating mode, maintaining power consumption of at least one element of the computing system at a reduced level while enabling use of the computing system in the quiet operating mode.

2. The method of claim 1 wherein maintaining the reduced power consumption comprises maintaining an operating voltage of at least one processor of the computing system at a reduced level.

3. The method of claim 1 further comprising receiving the indication to enter the quiet operating mode via a quiet operating mode button.

4. The method of claim 1 further comprising receiving the indication in response to a timer event.

5. The method of claim 1 wherein maintaining the reduced power consumption comprises maintaining a clock rate of at least one processor of the computing system at a reduced level.

6. The method of claim 1 further comprising automatically leaving the quiet operating mode in response to a timer event.

7. The method of claim 1 further comprising controlling output of an audio signal by the computing system while in the quiet operating mode.

8. The method of claim 1 further comprising preventing output of an audio signal by the computing system while in the quiet operating mode.

9. The method of claim 1 wherein receiving the indication comprises receiving an indication of a level of the quiet operating mode.

10. A computing system, comprising:
a module configured to receive an indication to enter a quiet operating mode and, in response to the request, maintain power consumption of at least one element of the computing system at a reduced level while enabling use of the computing system in the quiet operating mode.

11. The system of claim 10 wherein the module is configured to maintain an operating voltage of at least one processor of the computing system at a reduced level.

12. The system of claim 10 further comprising a timer coupled to the module and configured to generate the indication in response to a timer event.

13. The system of claim 10 wherein the module is configured to maintain a clock rate of at least one processor of the computing system at a reduced level.

14. The system of claim 10 wherein the indication to enter the quiet operating mode is received via a quiet operating mode button of the computing system.

15. The system of claim 10 wherein the module is configured to automatically leave the quiet operating mode in response to a timer event.

16. The system of claim 10 wherein the module is configured to control output of an audio signal by the computing system while in the quiet operating mode.

17. The system of claim 10 wherein the module is configured to prevent output of an audio signal by the computing system while in the quiet operating mode.

18. A computer program embodied on a computer-readable medium and, when executed by a processor, is operable to:
receive an indication to enter a quiet operating mode and, in response to the request, maintain power consumption of at least one element of the computing system at a reduced level while enabling use of the computing system in the quiet operating mode.

19. The computer program of claim 18 wherein, when executed by the processor, is configured to maintain an operating voltage of at least one processor of the computing system at a reduced level.

20. The computer program of claim 18 wherein, when executed by the processor, is configured to maintain a clock rate of at least one processor of the computing system at a reduced level.

21. A computing system, comprising:
in response to receiving an indication by the computing system to enter a quiet operating mode, means for maintaining power consumption of at least one means of the computing system at a reduced level while enabling use of the computing system in the quiet operating mode.

22. The system of claim 21 wherein the maintaining means comprises means for maintaining an operating voltage of at least one processing means of the computing system at a reduced level.

23. The system of claim 21 wherein the maintaining means comprises means for maintaining a clock rate of at least one processing means of the computing system at a reduced level.

24. The system of claim 21 wherein the maintaining means comprises means for entering the quiet operating mode in response to a timer event.
